(19) United States
(12) Patent Application Publication
(10) Pub. No.: US 2009/0116419 A1
(43) Pub. Date: May 7, 2009

(54) METHOD AND SYSTEM OF THRESHOLD SELECTION FOR RELIABLE RELAY STATIONS GROUPING FOR DOWNLINK TRANSMISSION

(76) Inventors: Chia-Chin Chong, Santa Clara, CA (US); Fujio Watanabe, Union City, CA (US); Hiroshi Inamura, Cupertino, CA (US)

Correspondence Address: Haynes and Boone, LLP;IP Section, 2323 Victory Avenue, SUITE 700, Dallas, TX, 75219, US

(21) Appl. No.: 12/257,325

(22) Filed: Oct. 23, 2008

Related U.S. Application Data
(60) Provisional application No. 60/985,601, filed on Nov. 5, 2007.

(51) Int. Cl. H04H 20/71

(52) U.S. Cl. 370/312; 455/3.01

(57) ABSTRACT

A relaying selection and cooperative communications method provides a threshold selection criterion for forming a reliable group of relay stations (RSs) based on one or more design criteria. Possible design criteria include an outage probability constraint and a throughput constraint. The threshold value is selected according to, for example, transmission paths (e.g., line-of-sight, obstructed-light-of-sight, non-light-of-sight) or channel conditions (e.g., signal-to-noise-ratio) between the base station (BS) and the RSs (i.e., BS-RSs link) and between the RSs and the mobile station (MS) (i.e., RSs-MS link), respectively.

### CROSS REFERENCE TO RELATED APPLICATIONS

The present application relates to and claims priority of U.S. provisional application (“Copending Provisional Application”), Ser. No. 60/985,601, entitled “Method and System of Threshold Selection for Reliable Relay Stations Grouping for Downlink Transmission,” by C. Chong et al., filed on Nov. 5, 2007.

The present application is also related to U.S. provisional patent applications, (a) Ser. No. 60/947,153, entitled “Method and System for Reliable Relay-Associated Transmission Scheme” (“Wang I”), naming as inventors D. Wang, C. C. Chong, I. Guvenc and F. Watanabe, filed on Jun. 29, 2007; and (b) Ser. No. 60/951,532, entitled “Method and System for Opportunistic Cooperative Transmission Scheme” (“Wang II”), naming as inventors D. Wang, C. C. Chong, I. Guvenc and F. Watanabe, filed on Jul. 24, 2007.

The present invention is also related to U.S. patent application (“Copending Non-provisional application”), entitled “Method and System for Reliable Relay-Associated and Opportunistic Cooperative Transmission Schemes,” Ser. No. 12/130,807, filed on May 30, 2008.

The disclosures of the Copending Provisional Application, the Copending Non-Provisional Application, Wang I and Wang II are hereby incorporated by reference in their entireties.

### BACKGROUND OF THE INVENTION

1. Field of the Invention

The present invention relates to a data communication network supporting mobile devices. In particular, the present invention relates to reliable data transmission in such a data communication network using relay stations.

2. Discussion of the Related Art

In wireless data communication networks, relay selection algorithms and cooperative diversity protocols are implemented via distributed virtual antennas to improve reliability. Improved reliability is achieved by creating additional paths between a source (e.g., base station or “BS”) and a destination (e.g., a mobile station or “MS”) using intermediate relay nodes (“RSs”).

User cooperation provides transmission diversity for MSs. Protocols using user cooperation are disclosed, for example, in the articles (a) “User cooperation diversity. Part I: System description” (“Sendonaris I”), by A. Sendonaris, E. Erkip, and B. Aazhang, published in IEEE Trans. Commun., vol. 51, no. 11, pp. 1927-1938, November 2003; and (b) “User cooperation diversity. Part II: Implementation aspects and performance analysis” (“Sendonaris II”), by A. Sendonaris, E. Erkip, and B. Aazhang, published in IEEE Trans. Commun., vol. 51, no. 11, pp. 1939-1948, November 2003. Sendonaris I and II assume knowledge of the forward channel and describe a beamforming technique which requires the source and a relay node to adjust the phases of their respective transmissions, so that their transmissions can add coherently at the destination. However, such a method requires considerable modifications to existing radio-frequency front-ends, which increase both the complexity and cost of the transceivers.

The article “Distributed space-time-coded protocols for exploiting cooperative diversity in wireless networks” (“Laneman I”), by J. N. Laneman and G. W. Wornell, published in IEEE Trans. Inf. Theory, vol. 49, no. 10, pp. 2415-2425, October 2003, discloses relay and cooperative channels that allow the MSs to transmit and receive simultaneously (i.e., full-duplex). To exploit coherent transmission, Laneman I assumes that channel state information (CSI) is available at the transmitters (TXs). Furthermore, Laneman I focuses on ergodic settings and characterizes performance using Shannon capacity regions. A later article, “Cooperative diversity in wireless networks: Efficient protocols and outage behavior” (“Laneman II”), by J. N. Laneman, D. N. C. Tse, and G. W. Wornell, published in IEEE Trans. Inf. Theory, vol. 51, no. 12, pp. 3062-3080, December 2004, discloses lower complexity cooperative diversity protocols that employ half-duplex transmissions. In Laneman II, no CSI is assumed available at the TXs, although CSI is assumed available at the receivers (RXs). As a result, beamforming capability is not used in Laneman II. Laneman II focuses on non-ergodic or delay-constrained situations. At a given rate, cooperation with half-duplex operation (as discussed in Laneman II) requires twice the bandwidth as of direct transmission. The increased bandwidth leads to greater effective signal-to-noise ratio (SNR) losses at higher spectral efficiency. Furthermore, depending on the application, additional receiver hardware may be required to allow the sources to relay for each other, especially in a cellular system using frequency-division duplexing.

The diversity-multiplexing tradeoff for cooperative diversity protocols with multiple relays was studied in both Sendonaris I and the article, “On the achievable diversity-vs-multiplexing tradeoff in cooperative channels” (“Azarian”), by K. Azarian, H. E. Gamal, and P. Schniter, and published in the IEEE Trans. Inf. Theory, vol. 51, pp. 4152-4172, December 2005. Sedonaris I discloses orthogonal transmission between source and relays, and Azarian discloses simultaneous transmissions in the source and the relays. In particular, Azarian involves a design of cooperative transmission protocols for delay-limited coherent fading channels, with each channel consisting of single-antenna, half-duplex nodes. Azarian shows that, by relaxing the orthogonality constraint, considerable performance improvement may be achieved because resources are used more efficiently (although incurring a higher complexity at the decoder).

The approaches of Sendonaris I and Azarian are information theoretic in nature, and the design of practical codes having the desired characteristics is left for further investigation. Practical code design is difficult and is a subject matter of active research, although space-time codes for the “real” multiple-input-multiple-output (MIMO) link (where the antennas belong to the same central terminal) are disclosed in “Lattice coding and decoding achieve the optimal diversity-multiplexing tradeoff of MIMO channels” (“Gamal”), by H. E. Gamal, G. Caire, and M. O. Damen, and published in IEEE Trans. Inf. Theory, vol. 50, no. 6, pp. 968-985, June 2004. According to Sendonaris I, how such codes may provide residual diversity without sacrificing achievable data rates is unclear. In other words, practical space-time codes for cooperative relay channels—where antennas belonging to different terminals are distributed in space—are fundamentally different from the space-time codes for “real” MIMO link channel.

The relay channel is fundamentally different from the “real” MIMO link because information is not known to the RSs a priori, but has to be communicated over noisy links. Moreover, the number of participating antennas is not fixed, but depends not only on the number of participating RSs, but the number of such RSs that can successfully relay the information transmitted from the source. For example, for a decode-and-forward relay, successful decoding must precede retransmission. For amplify-and-forward relays, a good received SNR is necessary. Otherwise, such relays forward mostly their own noise. See, e.g., “Fading relay channels: Performance limits and space-time signal design” (“Nabar”), by R. U. Nabar, H. Bolcskei, and F. W. Kneubuhler, published in IEEE J. Sel. Areas Commun., vol. 22, no. 6, pp. 1099-1109, June 2004. Therefore, the number of participating antennas in cooperative diversity schemes is in general random. Space-time coding schemes invented for a fixed number of antennas have to be appropriately modified.

The relay selection methods discussed in Sendonaris I and II, Laneman I and II, and Azarian all require distributed space-time coding algorithms, which are still unavailable for situations involving more than one RS. For example, relaying schemes, such as those disclosed in Sendonaris I, require an orthogonal transmission between the source and the relays. Such relaying schemes are usually difficult to maintain in practice.

Apart from practical space-time coding for the cooperative relay channel, the formation of virtual antenna arrays using individual RSs distributed in space requires significant amount of coordination. Specifically, forming cooperating groups of RSs involves distributed algorithms (see, e.g., Sendonaris I), while synchronization at the packet level is required among several different TXs. Those additional requirements for cooperative diversity demand significant modifications to many layers of the communication stack (up to the routing layer) that has been built according to conventional point-to-point, non-cooperative communication systems.

The article “Practical relay networks: A generalization of hybrid-ARQ” (“Zhao”) by B. Zhao and M. C. Valenti, published in IEEE J. Sel. Areas Commun., vol. 23, no. 1, pp. 7-18, January 2005, discloses an approach which involve multiple relays operating over orthogonal time slots, based on a generalization of the hybrid-automatic repeat request (HARQ) scheme. Unlike a conventional HARQ scheme, retransmitted packets need not be transmitted from the original source, but may be provided by relay nodes that overhear the transmission. The best relay may be selected based on its location relative to both the source and the destination. Because such a scheme requires knowledge of distances between all relays and the destination, a location determination mechanism (e.g., global positioning system (GPS)) is required at the destination to perform distance estimation. Alternatively, the destination may rely on a RX that can perform distance estimation using expected SNRs. For a mobile network, location estimation is necessarily repeated frequently, resulting in substantial overhead. Such a relaying scheme is therefore more appropriate for a static network than a mobile network. Relaying protocols such as Zhao's are truly cross-layer, involving mechanisms from both the medium access control (MAC) and the routing layers. Because more than one RS listens to each transmission, such relaying schemes are complex, so that an upper limit on the number of relays that should be used in any given situation is appropriate. Furthermore, the MAC protocol layer becomes more complicated, because it is required to support relay selection.

RS selection may be achieved by geographical routing, which is discussed in the article “Geographic random forwarding (GeRaF) for ad hoc and sensor networks: Multihop performance” (“Zorzi”), by M. Zorzi and R. R. Rao, published in IEEE Trans. Mobile Comput., vol. 2, no. 4, pp. 337-348, October-December 2003. Similar HARQ-based schemes are discussed in the articles (a) “Achievable diversity-multiplexing-delay tradeoff in half-duplex ARQ relay channels” (“Tabet”), by T. Tabet, S. Dusad and R. Knopp, published in Proc. IEEE Int. Sym. On Inf. Theory, Adelaide, Australia, pp. 1828-1832, September 2005; and (b) “Hybrid-ARQ in multihop networks with opportunistic relay selection” (“Lo”), by C. K. Lo, R. W. Heath, Jr. and S. Vishwanath, published in Proc. IEEE Int. Conf. on Acoustics, Speech, and Signal Proc., Honolulu, Hi., USA, April 2007. Tabet and Lo are applicable to delay-limited fading single relay channel.

U.S. Patent Application Publication 2006/0239222 A1, entitled “Method of providing cooperative diversity in a MIMO wireless network” (“Kim”), naming as inventors S. Kim and H. Kim, filed Oct. 26, 2006, discloses a method for providing cooperative diversity in a MIMO wireless network. In Kim, the RSs check for errors, relay the correct streams and request retransmission of error streams from the BS. Zhao, Tabet, Lo and Kim's methods all involve only one RS and thus do not benefit from cooperative diversity.

In most conventional cooperative diversity schemes, the BS retransmits packets, even when only one RS fails to receive the reliable packets. See, e.g., the article “An ARQ in 802.16j” (“Yoon”), by S. Jin, C. Yoon, Y. Kim, B. Kwak, K. Lee, A. Chindapol and Y. Saifullah, published in IEEE C802.16j-07/250r4, March 2007. Yoon's scheme may introduce latency or even a deadlock between the BS and RSs, as the number of RSs increases.

Other schemes select the “best RS” based on instantaneous channel conditions. See, e.g., the article “A simple distributed method for relay selection in cooperative diversity wireless networks based on reciprocity and channel measurements” (“Bletsas”), by A. Bletsas, A. Lippman, and D. P. Reed, published in Proc. IEEE Vech. Technol. Conf., vol. 3, Stockholm, Sweden, May 30-Jun., 1 2005, pp. 1484-1488. Bletsas's scheme is very complex, especially in a fast-moving mobile environment. Furthermore, fast switching among RSs increases the workload and overhead of the central controller. Therefore, the selection of “best RS” based on instantaneous channel conditions is less appropriate for fast-moving mobile environments (e.g., outdoor environment) than for static or nomadic environments (e.g., indoor environment).

A threshold-based opportunistic cooperative ARQ transmission approach is disclosed in Wang I and II. In Wang I and II, transmission between the BS and the MS can be separated into two parts—i.e., between the BS and the RSs (the “BS-RSs link”) and between RSs and MS (the “RSs-MS link”). The messages for acknowledgement in Wang I and II are different from conventional acknowledgement or negative acknowledgment messages (ACK/NACK) used for unicast transmission. In particular, two new types of ARQ messages are introduced for multicast transmission. These ARQ messages are the relay associated ACK/NACK (i.e., R-ACK/R-NACK) for BS-RSs link, and the cooperative ACK/NACK (i.e., C-ACK/C-NACK) for the RSs-MS link. Here, a pre-defined threshold is applied to evaluate the reliability of the BS-RSs link. If the number of reliable RSs is larger than the threshold value, the reliable RSs transmit the packet to the MS in a cooperative manner.

U.S. Patent Application Publication 2007/016558, entitled “Method and system for communicating in cooperative relay networks” (“Mehta”), naming as inventors N. B. Mehta, R. Madan, A. F. Molisch, J. Zhang, filed on Jul. 19, 2007, discloses a method for communicating in cooperative relay networks. In Mehta, a network consists of one source, N relay nodes and one destination. Mehta deploys cooperative transmission to send packets and to minimize power consumption in the network. Mehta assumes that all channels between nodes (i.e., destination-relays and relays-node) are independent, flat Rayleigh-fading and all channels are reciprocal. Transmissions in Mehta's system are assumed to occur at a fixed data rate and at a fixed transmission power value. In general, a relay node is considered to have successfully decoded a signal from the source, when the SNR of its received signal exceeds a predetermined threshold. This threshold value depends on the bit rate and transmission power (i.e., purely based on a Shannon capacity formulation). When all relay nodes successfully decode a signal from the source, a predetermined number of relay nodes (e.g., M out of N relay nodes) forward the received signal to the destination. The number M of forwarding RSs is selected based on the threshold value discussed above. The destination then estimates the CSI for each channel between it and the M relay nodes. Based on the CSI, the destination selects a subset of K relay nodes. Here, K is selected based on the outage at the destination, which is a function of M. The destination then feeds back the CSI to the M relay nodes. This feedback information is also forwarded to the source to allow the source to broadcast future data packets to the K relay nodes. The K relay nodes that are selected to forward the data packets to the destination then adjust their transmission powers accordingly, so as to cooperatively beamform the data to the destination, while minimizing the total power consumption in the network.

Under Mehta's scheme, the selection rule is implemented in the destination node. Therefore, Mehta's scheme suffers from three disadvantages. First, the K effective relay nodes that forward data packets are determined and controlled by the destination, and not by the source. Such a scheme is not suitable for a centralized network, such as a cellular network. Second, Mehta's scheme lacks flexibility because the threshold selection scheme depends on the bit rate, so that modulation schemes deployed at the source and the relay nodes may undesirably change the threshold value. Third, Mehta's scheme incurs large overhead because the K effective relay nodes used for data packets transmission are determined after processing at two levels of the network—i.e., first at the relay nodes, selecting M relay nodes out of N relay nodes, and then at the destination node, selecting K relay nodes out of M relay nodes.

Except for Tabet, the schemes discussed above ignore the situation in which an RS which does not receive reliable information from the BS may be able to overhear the transmission between the reliable RSs and the MSs. Tabet has the drawback of focusing on selecting one RS at each hop. Wang I and II do not discuss a criterion to set the threshold value that determines the number of reliable RSs.

### SUMMARY OF THE INVENTION

According to one embodiment of the present invention, a relaying selection and cooperative communications method provides a threshold selection criterion for forming a reliable group of relay stations (RSs) based on one or more design criteria. Possible design criteria include an outage probability constraint and a throughput constraint. The threshold value is selected according to, for example, transmission paths (e.g., line-of-sight, obstructed-light-of-sight, non-light-of-sight) or channel conditions (e.g., signal-to-noise-ratio) between the base station (BS) and the RSs (i.e., BS-RSs link) and between the RSs and the mobile station (MS) (i.e., RSs-MS link), respectively.

The present invention is better understood upon consideration of the detailed description below, in conjunction with the drawings.

### BRIEF DESCRIPTION OF THE DRAWINGS

FIG. 1 shows a cooperative relay transmission scheme (more specifically, a cooperative multicast relay transmission scheme), according to the Copending Non-provisional application incorporated by reference above.

FIG. 2 shows flowchart 200, which summarizes a threshold selection criterion for reliable RSs grouping based on the outage probability constraint, according to one embodiment of the present invention.

FIG. 3 is flowchart 300, which summarizes a threshold selection criterion for reliable RSs grouping based on the throughput constraint, in accordance with one embodiment of the present invention.

FIG. 4 shows a transmissions and message exchange protocol used in the two-part downlink signal transmission over the BS-RSs link and RSs-MS link, in accordance with the present invention.

### DETAILED DESCRIPTION OF THE PREFERRED EMBODIMENTS

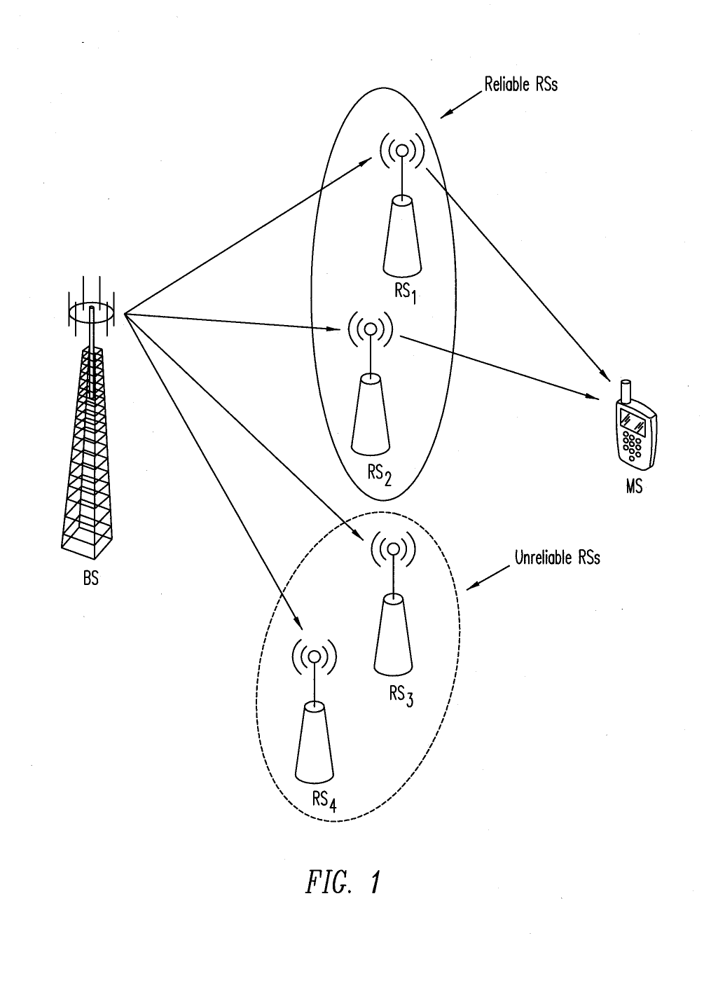

FIG. 1 shows a cooperative relay transmission scheme (more specifically, a cooperative multicast relay transmission scheme), according to the Copending Non-provisional application incorporated by reference above. Under this scheme, transmission between the BS and the MS can be separated into two parts—i.e., between the BS and the RSs (the “BS-RSs link”) and between RSs and MS (the “RSs-MS link”). The channel conditions in these two parts are characterized by their respective SNRs. Here, a pre-defined threshold value allows evaluation of the reliability of the BS-RSs link. If the number of reliable RSs is larger than this threshold value, the reliable RSs transmit the packet to the MS in a cooperative manner. According to this scheme, only reliable RSs transmit packets to the MS, while unreliable RSs remain passive.

According to one embodiment of the present invention, a threshold selection criterion is applied to form a reliable RSs group. A threshold value υ is selected based on channel conditions between the BS-RSs link (i.e., SNR₁) and between RSs-MS link (i.e., SNR₂), respectively. Generally, a high SNR value is typical under line-of-sight (LOS) condition, while a low SNR value is typical under an obstructed-LOS (OLOS) condition, a non-LOS (NLOS) condition, or both. Threshold υ can be selected to meet the following design criteria:

1. Outage Probability Constraint—an outage probability P refers to the probability that a packet is lost, given by:

$$\begin{matrix}P = P ( {E}_{1}^{c} ⋃ {E}_{2}^{c} ⋃ … ⋃ {E}_{{L}_{max}}^{c} ⋃ {E}_{} ⋃ {E}_{L , 1}^{′ c} ) \\ = {\sum }_{k = 1}^{{L}_{max}} P ( {E}_{k}^{c} ) + P ( {E}_{L , 1}^{′ c} ) + P ( {E}_{} )\end{matrix} , \qquad ( 1 )$$

where Lₘₐₓ is the maximum number of transmissions used for a packet, P(Eₖ^{c}) P(E′_{L,1}^{c}), and P(E_{Ø}) are the probabilities that events Eₖ^{c}, E′_{L,1}^{c}, and E_{Ø} occur, respectively. Events Eₖ^{c}, E′_{L,1}^{c}, and E_{Ø} are defined by:
Eₖ^{c}: the event that the RSs do not receive an ACK message from the MS with the condition of Q_{υ}≧υ, L₁(n)=k for 1≦k≦Lₘₐₓ and L₂(n)=Lₘₐₓ−k+1.
E′_{L,1}^{c}: the event that the RSs do not receive an ACK message from the MS with the condition of 0<Q_{υ}<υ, L₁(n)=Lₘₐₓ and L₂(n)=1.
E_{Ø}: the event that none of the RSs receive the transmitted packets correctly from the BS within Lₘₐₓ transmissions.

The value Q_{υ} is the number of RSs within the mobile data network, υ is the threshold that determines the minimum number of reliable RSs required to initiate the transmission in the BS-RSs link, L₁(n), L₂(n), and L(n)=L₁(n)+L₂(n)−1 are the number of transmission used for the n-th packet in the BS-RSs link, RSs-MS link, and overall transmission link, respectively.

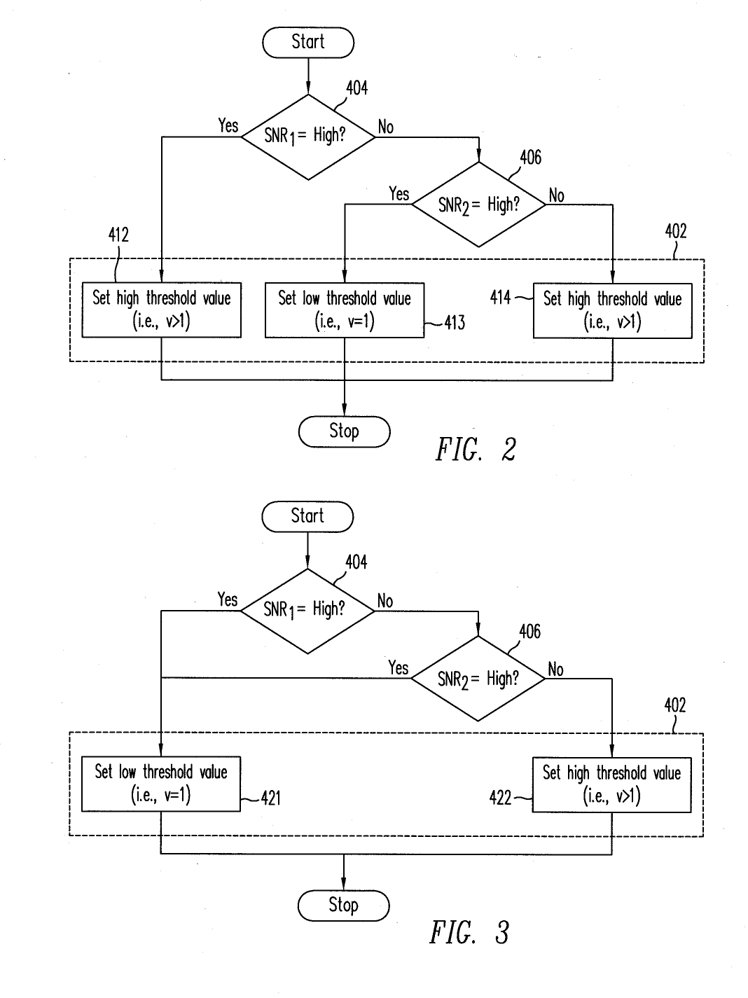

FIG. 2 shows flowchart 200, which summarizes a threshold selection criterion for reliable RSs grouping based on the outage probability constraint, according to one embodiment of the present invention. As shown in FIG. 2, at step 404, when the signal condition at the BS-RSs link is good (i.e., a high SNR₁), a large threshold value (e.g., υ>1) is selected at step 412, so that a larger number of RSs form the reliable group. This value for threshold value υ is selected because, when the signal condition at the BS-RSs link is good, the probability that a greater number of RSs are likely to receive a transmitted packet correctly from the BS is high. As a result, the cooperative diversity gain in the second part of transmission is increased and thus, the outage probability is reduced.

However, as shown in step 406, when the signal condition at the BS-RSs link is weak (i.e., a low SNR₁), the threshold value υ is selected according to the channel condition of RSs-MS link (step 406). In particular, at step 406, for a high SNR₂, a small value for threshold value υ is selected (e.g., υ=1, at step 413) to avoid packet loss during the first part of transmission (i.e., the outage probability performance is dominated by the BS-RSs link). When the signal condition at the RSs-MS link is strong, the probability that the MS receive a packet correctly from an RS is high. On the other hand, for a low SNR₂, a high value for threshold value υ is selected (e.g., υ>1, at step 414) to ensure that at least one of the RS within the reliable group would have an acceptable overall link with both the BS and the MS. Note that, under the threshold selection criterion of FIG. 2, when SNR₁ is high, threshold value υ can be set independently of SNR₂.

2. Throughput Constraint—Throughput, S refers to the average number of correctly received packets per transmission, given by:

$$S = \frac{1 - P}{\overline{T}} \qquad ( 2 )$$

where P is the outage probability given in equation (1) above and T̅ is the total number of transmissions required to transmit a packet (i.e., delay of a packet). T̅ is given by:

$$\begin{matrix}\overline{T} = {\sum }_{k = 1}^{{L}_{max}} {\sum }_{l = 1}^{{L}_{max} - k + 1} ( k + l - 1 ) P ( {E}_{k , l} ) + {L}_{max} P ( {E}_{L , 1}^{′ } ) + {L}_{max} P \\ = \frac{{\sum }_{k = 1}^{{L}_{max}} {\sum }_{l = 1}^{{L}_{max} - k + 1} ( k + 1 - 1 ) P ( {E}_{k , l} ) + {L}_{max} P ( {E}_{L , 1}^{′ } )}{{\sum }_{k = 1}^{{L}_{max}} {\sum }_{l = 1}^{{L}_{max} - k + 1} P ( {E}_{k , l} ) + P ( {E}_{L , 1}^{′ } )}\end{matrix} \qquad ( 3 )$$

where P(E_{k,l}) and P(E′_{L,1}) are the probabilities that events E_{k,l} and E′_{L,1} occur, respectively. Events E_{k,l} and E′_{L,1} are defined as:
E_{k,l}: the event that the RSs receive an ACK message from the MS with the condition of Q_{υ}≧υ, L₁(n)=k for 1≦k≦Lₘₐₓ and L₂(n)=l for 1≦l≦Lₘₐₓ−k+1.
E′_{L,1}: the event that the RSs receive an ACK message from MS with the condition of 0<Q_{υ}<υ, L₁(n)=Lₘₐₓ and L₂(n)=1.

FIG. 3 is flowchart 300, which summarizes a threshold selection criterion for reliable RSs grouping based on the throughput constraint, in accordance with one embodiment of the present invention. As shown in FIG. 3, at step 404, when the signal condition at the RSs-MS link is strong (i.e., a high SNR₂), regardless of the SNR values at the BS-RSs link, a small value for threshold value υ is selected (e.g., υ=1, at step 421). Such a selection is appropriate because, the gain in cooperative diversity brought about by a large value for threshold value υ does not sufficiently compensate the longer delay required to form a larger reliable group in the first part of the transmission (i.e., BS-RSs link). On the other hand, when the signal condition at RSs-MS link is weak (i.e., a low SNR₂), a large value for threshold value υ is selected (e.g., υ>1, at step 422). Such a selection is appropriate because of the large delay in the second part of transmission (i.e., RSs-MS link) becomes severe due to weak channel condition. Therefore, a larger value for threshold value υ reduces the delay by exploiting cooperative diversity.

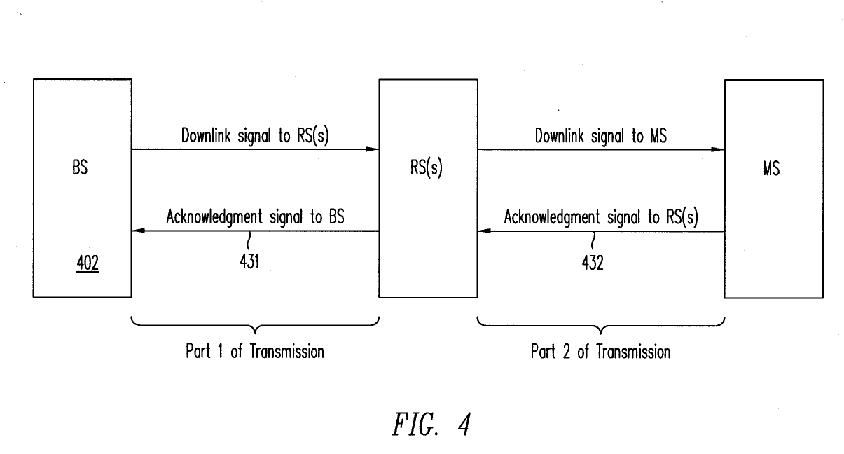

FIG. 4 shows a transmissions and message exchange protocol used in the two-part downlink signal transmission over the BS-RSs link and RSs-MS link, in accordance with the present invention. As shown in FIG. 4, the SNR of the BS-RSs link (i.e., SNR₁) can be fed back to BS via an acknowledgment signal (431) or another form of message exchange from the RSs. Based on this feed back, the BS can adjust SNR₁ by changing its transmission power. Similarly, the SNR of RSs-MS link (i.e., SNR₂) can be fed back to the RSs by an acknowledgment signal (432) or another form of message exchange from the MS. This acknowledgment signal may be provided, for example, during the initial and periodical ranging processes for forming a relay-associated group of RSs (“R-group”), such as that described in the Copending Non-provisional application incorporated by reference above.

A method according to the present invention has a significant advantage over the prior art because of its flexibility and capability to set a threshold value based on channel conditions to form a reliable group of RSs under a cooperative multicast relay transmission scheme. A method of the present invention enables a cellular network to optimize its performance by controlling a threshold value that is based on outage probability or throughput.

The above detailed description is provided to illustrate specific embodiments of the present invention and is not intended to be limiting. Numerous modifications and variations within the scope of the present invention are possible. The present invention is set forth in the following claims.

We claim:

1. A method for selecting a threshold value for determining a reliable relay station group, under a cooperative multicast relay downlink transmission scheme, comprising:
evaluating a first signal condition between a transmitter and one or more relay stations; and
assigning a first value to the threshold value, when the first signal condition is stronger than a first predetermined value; otherwise:
evaluating a second signal condition between the one or more relay stations and a destination, and
assigning a second value less than the first value to the threshold value, when the second signal condition is stronger than a second predetermined value, and assigning a third value greater than the second value to the threshold value, otherwise.

2. A method as in claim 1, wherein the first and second signal conditions are determined based on whether or not a line-of-sight condition, a non-line-of-sight condition or an obstructed-line-of-sight condition exists.

3. A method as in claim 1, wherein the first and second signal conditions are evaluated based on a signal-to-noise ratio.

4. A method as in claim 1, wherein the method reduces a probability of a lost packet.

5. A method for selecting a threshold value for determining a reliable relay station group, under a cooperative multicast relay downlink transmission scheme, comprising:
evaluating a first signal condition between a transmitter and one or more relay stations; and
assigning a first value to the threshold value, when the first signal condition is stronger than a first predetermined value; otherwise:
evaluating a second signal condition between the one or more relay stations and a destination, and
assigning the first value to the threshold value, when the second signal condition is stronger than a second predetermined value, and assigning a second value to the threshold value, otherwise.

6. A method as in claim 5, wherein the first and second signal conditions are determined based on whether or not a line-of-sight condition, a non-line-of-sight condition or an obstructed-line-of-sight condition exists.

7. A method as in claim 5, wherein the first and second signal conditions are evaluated based on a signal-to-noise ratio.

8. A method as in claim 5, wherein the method results in increasing an average number of correctly received packets per transmission.

9. A two-part transmission system to a destination, comprising:
a transmitter; and
a plurality of relay stations, wherein the transmitter transmit a data packet to a subset of the relay stations, which forward the data packet to the destination and wherein the subset is determined according to a threshold value determined by a method that comprises:
evaluating a first signal condition between a transmitter and one or more relay stations; and
assigning a first value to the threshold value, when the first signal condition is stronger than a first predetermined value; otherwise:
evaluating a second signal condition between the one or more relay stations and a destination, and
assigning a second value less than the first value to the threshold value, when the second signal condition is stronger than a second predetermined value, and assigning a third value greater than the second value to the threshold value, otherwise.

10. A two-part transmission system as in claim 9, wherein the first and second signal conditions are determined based on whether or not a line-of-sight condition, a non-line-of-sight condition or an obstructed-line-of-sight condition exists.

11. A two-part transmission system as in claim 9, wherein the first and second signal conditions are evaluated based on a signal-to-noise ratio.

12. A two-part transmission system as in claim 9, wherein the method reduces a probability of a lost packet.

13. A two-part transmission system to a destination, comprising:
a transmitter; and
a plurality of relay stations, wherein the transmitter transmit a data packet to a subset of the relay stations, which forward the data packet to the destination and wherein the subset is determined according to a threshold value determined by a method that comprises:
evaluating a first signal condition between a transmitter and one or more relay stations; and
assigning a first value to the threshold value, when the first signal condition is stronger than a first predetermined value; otherwise:
evaluating a second signal condition between the one or more relay stations and a destination, and
assigning the first value to the threshold value, when the second signal condition is stronger than a second predetermined value, and assigning a second value to the threshold value, otherwise.

14. A two-part transmission system as in claim 13, wherein the first and second signal conditions are determined based on whether or not a line-of-sight condition, a non-line-of-sight condition or an obstructed-line-of-sight condition exists.

15. A two-part transmission system as in claim 13, wherein the first and second signal conditions are evaluated based on a signal-to-noise ratio.

16. A two-part transmission system as in claim 13, wherein the method results in increasing an average number of correctly received packets per transmission.
